(19) United States
(12) Patent Application Publication
(10) Pub. No.: US 2007/0011881 A1
(43) Pub. Date: Jan. 18, 2007

(54) Foldable knife

(76) Inventor: Xiaoxia Cheng, Zhejiang Province (CN)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(21) Appl. No.: 11/484,904

(22) Filed: Jul. 12, 2006

(30) Foreign Application Priority Data
Jul. 14, 2005 (CN) 200520013330.0

(51) Int. Cl. B26B 1/02

(52) U.S. Cl. 30/155

(57) ABSTRACT

A foldable knife, comprising a blade, a knife head and a handle. The knife head has a movable part which can be pushed to press on a locking part. The locking part has two ends, one end is rotably fastened by a bolt to the knife head and another, a free end, has a catch. The blade has a notch on an edge opposite to a cutting edge. The catch corresponds to the notch. The blade may have two or more notches. The handle may be hollow and knife head is rotably fastened on the handle by a bolt. The knife head and the blade can be rotably folded at least partially into the handle.

### CROSS REFERENCE TO RELATED APPLICATIONS

This application claims priority from a Chinese Patent Application No. 200520013330.0, filed on Jul. 14, 2005.

### FIELD OF THE INVENTION

The present invention relates generally to hand tools.

### DESCRIPTION OF THE BACKGROUND

A utility knife is a tool for cutting hard materials such as leather, rubber, etc. It comprises a changeable knife blade and a knife body. Among the utility knives currently on the market, there are two main types of mechanisms for holding the knife blade onto the knife body. One type is bolt fastening. Another type is laterally pressuring. These two types of mechanisms have common problems of inconvenient to install the blade and difficult to tighten the blade. For the bolt fastening type, changing the knife blade is inconvenient, and a gap between the bolt and the blade would make the blade slightly movable, therefore affecting the precision of the cutting. Meanwhile, the size of the bolt cannot be too small. For the laterally pressuring type (i.e. the blade is installed by opening one side panel of a two-panel body, placing the blade inside, and closing the side panel using a U-shaped clamp to hold the two panels and blade together), has the problem of using only one edge of the body panels for applying the pressure to secure the blade. The pressure to secure the blade, coming from the U-shaped clamp, may not be strong enough, and the pressure is conducted by the body panels to the blade, not directly applied on the blade. When in operation, a force applied on the object being cut generates a reacting force on the knife. This reacting force may affect the stability of the blade.

### DISCLOSURE OF THE INVENTION

The present invention is designed to overcome the above limitations that are attendant upon the use of “prior art” utility knives, and toward this end, it contemplates the provision of a novel design for a foldable utility knife. The foldable utility knife of the present invention has the advantages of high stability in locking the blade, easy to change the blade, and structurally simple and sound.

The foldable knife of the present invention comprises a blade, a knife head and a handle, characterized in that the knife head has a movable part which can be pushed to press on a locking part; the locking part has two ends, one end is rotably fastened by a bolt to the knife head and another, a free end, has a catch; the blade has a notch on the edge opposite to the cutting edge; the catch corresponds to the notch.

In installing the blade, push the movable part backward towards the handle, lift the free end of the locking part, insert the blade, rotate the locking part downwards so that the catch falls into the notch, then push the moving part toward the blade so that it presses down the locking part to hold the blade into the place.

The installation of the blade is easy and fast. The structure of the knife is simple and sound. In addition, the knife head can be rotably folded towards the handle, which is hollow, so that the blade and the knife head can be stored inside the handle. This way, the volume of the knife is reduced for easy carrying.

### DESCRIPTION OF THE DRAWINGS

FIG. 1 is a schematic drawing of the present invention.

### DETAILED DESCRIPTION OF THE INVENTION

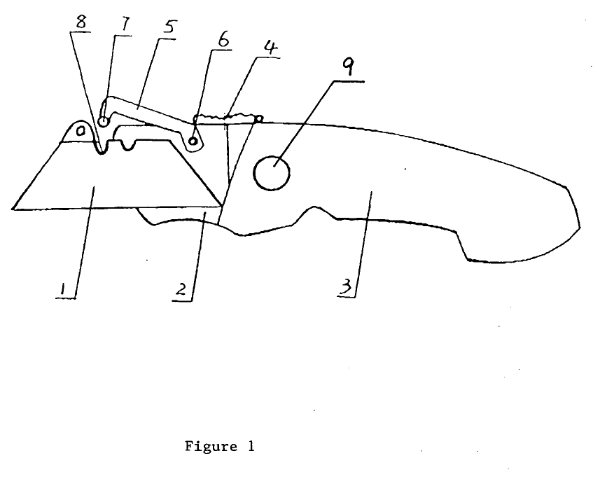

As shown in FIG. 1, the foldable knife of the invention comprises a blade 1, a knife head 2 and a handle 3, characterized in that: the knife head 2 has a movable part 4 which can be pushed to press on a locking part 5; the locking part 5 has two ends, one end is rotably fastened by a first bolt 6 to the knife head 2 and another, a free end, has a catch 7; the blade 1 has a notch 8 on the edge opposite to the cutting edge; the catch 7 corresponds to the notch 8.

The blade 1 may have two or more notches 8, for selecting different protruding lengths of the blade 1.

The knife head 2 is rotably fastened on the handle 3 by a second bolt 9. The handle 3 is hollow with an opening at one side. The knife head 2 and the blade 1 can be rotably folded toward the opening and at least partially into the handle 3, so that the blade 1 and the knife head 2 can be stored inside the handle 3. This way, the volume of the knife is reduced for easy carrying.

What is claimed is:

1. A foldable knife, comprising a blade (1), a knife head (2) and a handle (3), characterized in that:
the knife head (2) has a movable part (4) which can be pushed to press on a locking part (5), the locking part (5) has two ends, one end is rotably fastened by a first bolt (6) to the knife head (2) and another, a free end, has a catch (7), the blade (1) has a notch (8) on an edge opposite to a cutting edge; the catch (7) corresponds to the notch (8).

2. The foldable knife of claim 1, characterized in that the blade (1) has two or more notches (8) on the edge opposite to the cutting edge.

3. The foldable knife of claim 1, characterized in that the handle (3) is hollow with an opening at one side, the knife head (2) is rotably fastened on the handle (3) by a second bolt (9), the knife head (2) and the blade (1) can be rotably folded toward the opening and at least partially into the handle (3).
